(19) United States
(12) Patent Application Publication
(10) Pub. No.: US 2025/0052029 A1
(43) Pub. Date: Feb. 13, 2025

(54) IN-GROUND UTILITY ACCESS BOX AND RELATED METHODS

(71) Applicant: American Polymer Company, Pompano Beach, FL (US)

(72) Inventors: Scott Genovesi, Pompano Beach, FL (US); Sean Dvoran, Pompano Beach, FL (US)

(21) Appl. No.: 18/797,983

(22) Filed: Aug. 8, 2024

Related U.S. Application Data
(60) Provisional application No. 63/518,915, filed on Aug. 11, 2023.

(51) Int. Cl. E02D 29/12; H02G 9/10

(52) U.S. Cl. CPC E02D 29/12; H02G 9/10

(57) ABSTRACT

A utility access system may include a base, a plurality of sidewalls extending vertically upward from the base and connected together to define a cavity therein with an opening at a top thereof and a rim inside the opening, and a lid configured to close the opening when received by the rim. Each of the sidewalls may include a plurality of first and second ribs extending from the base to the rim, with the first ribs extending outwardly away from the rim and the second ribs extending inwardly beneath the rim, at least one first fin on each first rib outside of the rim, and at least one second rib on each second rib beneath the rim and coupled thereto.

### RELATED APPLICATIONS

This application claims the benefit of U.S. provisional application Ser. no. 63/518, 915 filed Aug. 11, 2023, which is hereby incorporated herein in its entirety by reference.

### TECHNICAL FIELD

The present disclosure generally relates to utility infrastructure, and more particularly to access boxes for utility infrastructure components and related methods.

### BACKGROUND

Various types of ground boxes or vaults are used to provide access points in a number of utility infrastructure applications. For example, pull boxes provide access to cables such as electrical or telecommunications lines. Other similar types of boxes provide access to valves, meters, and the like.

Such boxes are typically buried with the top of the box flush with the ground. A removable lid provides access to the infrastructure within when needed, and keeps the infrastructure otherwise closed off and protected when it is not. Various materials are used for such boxes, including concrete and polymer-based materials, for example.

### SUMMARY

A utility access system may include a base, a plurality of sidewalls extending vertically upward from the base and connected together to define a cavity therein with an opening at a top thereof and a rim inside the opening, and a lid configured to close the opening when received by the rim. Each of the sidewalls may include a plurality of first and second ribs extending from the base to the rim, with the first ribs extending outwardly away from the rim and the second ribs extending inwardly beneath the rim, at least one first fin on each first rib outside of the rim, and at least one second fin on each second rib beneath the rim and coupled thereto.

In an example embodiment, the first and second ribs may be arranged in an alternating fashion along each sidewall. Also by way of example, the at least one first fin may comprise a pair of spaced apart first fins at a top of each first rib. Similarly, the at least one second fin may comprise a pair of spaced apart second fins. In some embodiments, the first and second ribs may be elongated isosceles trapezoids. Furthermore, the base may comprise a webbed footer surrounding the cavity in an example implementation. In some embodiments, the base and plurality of sidewalls may define a unitary body, and they may comprise high-density polyethylene (HPDE), for example.

A related utility access vault, such as the one briefly described above, and method for making the vault are also provided. The method may include forming a base and a plurality of sidewalls extending vertically upward from the base and connected together to define a cavity therein with an opening at a top thereof and a rim inside the opening configured to receive a lid. Forming the sidewalls may include forming a plurality of first and second ribs extending from the base to the rim, with the first ribs extending outwardly away from the rim and the second ribs extending inwardly beneath the rim, forming at least one first fin on each first rib outside of the rim, and forming at least one second rib on each second rib beneath the rim and coupled thereto.

### BRIEF DESCRIPTION OF THE DRAWINGS

FIG. 1 is a top perspective view of a utility access box in accordance with an example embodiment.

FIG. 2 is a side view of the utility access box of FIG. 1.

FIG. 3 is a cross-sectional view of the utility access box of FIG. 2 taken along the line A-A.

FIG. 4 is a top view of the utility access box of FIG. 1.

FIG. 5 is a bottom perspective view of the utility access box of FIG. 1.

FIG. 6 is a top perspective view of two of the utility access boxes of FIG. 1 stacked one on top of another.

FIG. 7 is a side view of the stacked utility access boxes of FIG. 6.

FIG. 8 is a cross-sectional view of the stacked utility access boxes of FIG. 7 taken along line D-D.

FIG. 9 is a flow diagram illustrating a method for making a utility access box in accordance with an example embodiment.

### DESCRIPTION

Example embodiments will now be described more fully hereinafter with reference to the accompanying drawings, in which the example embodiments are shown. The embodiments may, however, be implemented in many different forms and should not be construed as limited to the specific examples set forth herein. Rather, these embodiments are provided so that this disclosure will be thorough and complete. Like numbers refer to like elements throughout.

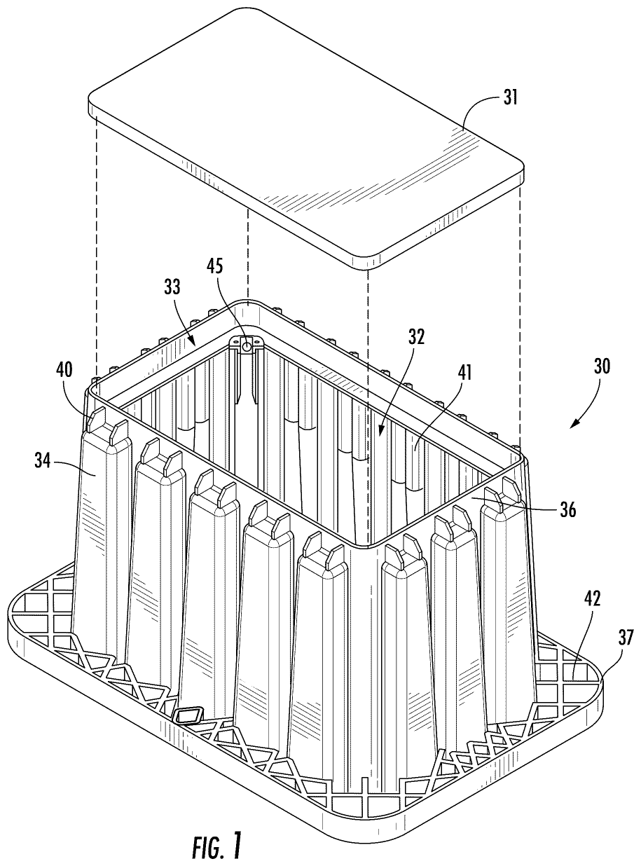

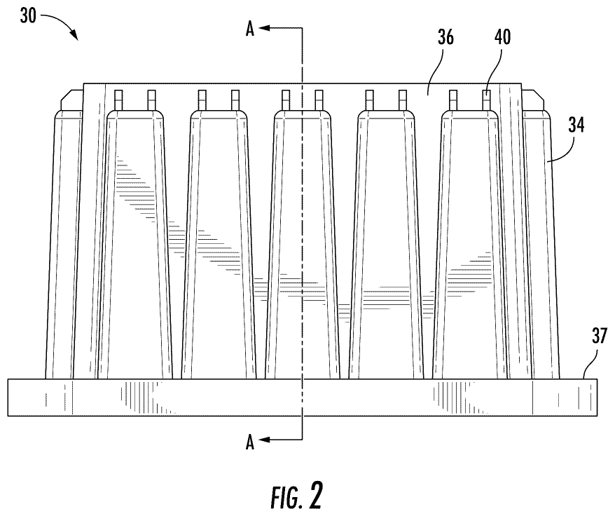

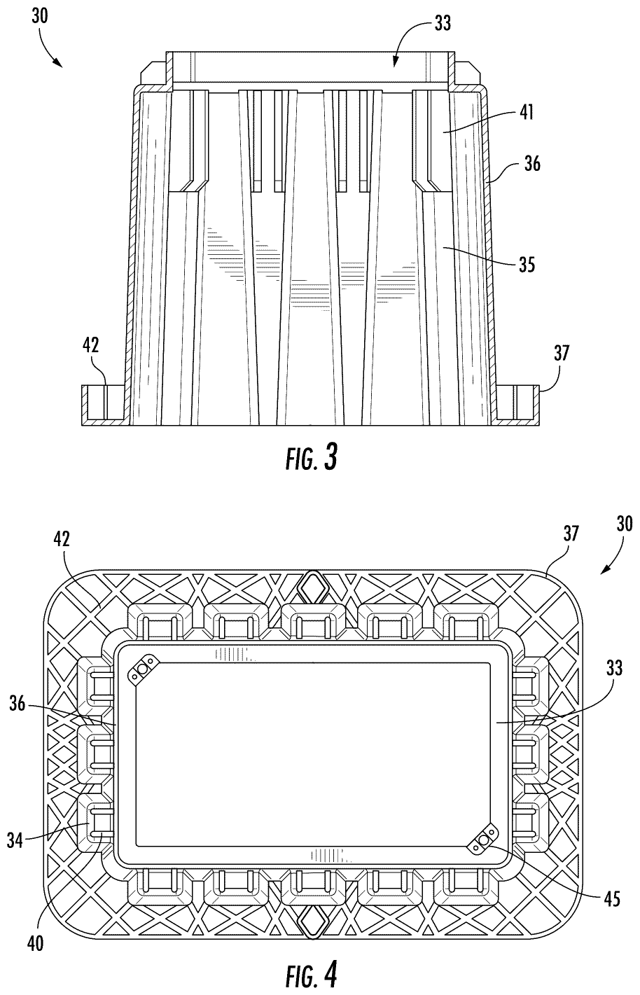

Referring initially to FIGS. 1-5, a utility access box or vault 30 in accordance with an example embodiment is first described. The box 30 is designed to be flush-mounted in the ground and receive a lid 31 in the top opening 32 illustrated in FIG. 1, which allows access to a cavity therein where the utility infrastructure is located (e.g., electrical wiring or components, telecommunications components, water/sewer components, traffic light components, meters, valves, etc.). Conventional lids 31 (e.g., polymer concrete, conventional concrete, etc.) may be used with the illustrated box 30, and in the illustrated configuration fits within the rimmed opening or rim 33 at the top of the box. As seen in FIG. 1, the lid 31 is sized to close the opening 32 when received by the rim 33.

Generally speaking, utility access boxes are positioned in locations where they may be subject to stress and heavy loads, such as along roadways. As such, they need to be sturdy enough to withstand such loads, which is why some of these boxes are made of concrete. However, transportation and storage of the boxes are also significant concerns, and thus lighter weight materials, such as polymer-based materials including high-density polyethylene (HDPE), are also used. A tiered scale is used to rate the strength of utility boxes, with tier 22 being the highest rating meant to withstand extreme loads such as being run over by a semi-tractor trailer.

The configuration of the illustrated box 30 provides a technical advantage of allowing fabrication from relatively light weight materials, such as HDPE (although other suitable materials may also be used, including concrete and polymer concrete or other polymer-based materials), while also providing enhanced structural stability high enough to achieve a tier 22 rating (although the present configuration may be used for lower-tiered box configurations as well). To achieve its structural rigidity, the box 30 illustratively includes outer (first) and inner (second) ribs 34, 35 along slanted or flared walls 36. In the present example, the exterior and interior ribs 34, 35 have a cross section resembling an elongated isosceles trapezoid (pyramids), although other shapes may be used in different embodiments (e.g., semi-cylindrical, triangular, etc.). As seen in FIGS. 1 and 5, the exterior and interior ribs 34, 35 alternate in an accordion-like or corrugated fashion, such that where the outer ribs protrude the inner ribs are recessed, and vice-versa. Moreover, the outer ribs 34 have their base (widest portion) at the bottom of the box 30, while the inner ribs 35 have their base at the top of the box (i.e., the exterior and interior ribs 34, 35 are inverted with respect to one another).

The sidewalls 36 of the box 30 extend vertically upward from a base 37 and are connected together to define the cavity therebetween and the opening 32 at a top of the box, with the rim 33 inside the opening. The exterior and interior ribs 34, 35 extend from the base 37 to the rim 33. More specifically, the exterior and interior ribs 34, 35 are in contact with and extend from the level of the base 37 all of the way up at least to the bottom level of the rim 33 in the illustrated example. Not only does this provide extra support and rigidity all of the way up the sides 36 of the box 30, but it also allows for extra reinforcement of the rim 33. Threaded inserts 45 or other suitable connectors may be included for securing the lid 31 (e.g., with screws, etc.).

In this regard, one or more exterior (first) fins 41 are positioned on the tops of the first ribs 34, and one or more interior (second) fins are carried on the interior fins 35. The exterior fins 40 are coupled to the sidewalls of the rim 33, while the interior fins 41 are coupled to the bottom of the rim, providing both lateral and vertical support to the rim when the cover 31 is under load. In the illustrated example, respective pairs of exterior fins 40 and interior fins 41 are carried by the exterior ribs 34 and interior ribs 35 for extra reinforcement and rigidity, although a single fin (or more than two fins) may be used on the exterior and/or interior in different embodiments. The ribs 34, 35 and fins 40, 41 advantageously provide desired structural stability or rigidity to help prevent excess deformity/bending of the box 30 under load, and achieve desired load ratings such as those noted above. Moreover, having the fins 40, 41 directly coupled to the ribs 34, 35 extends that structural stability to the rim 33 as well.

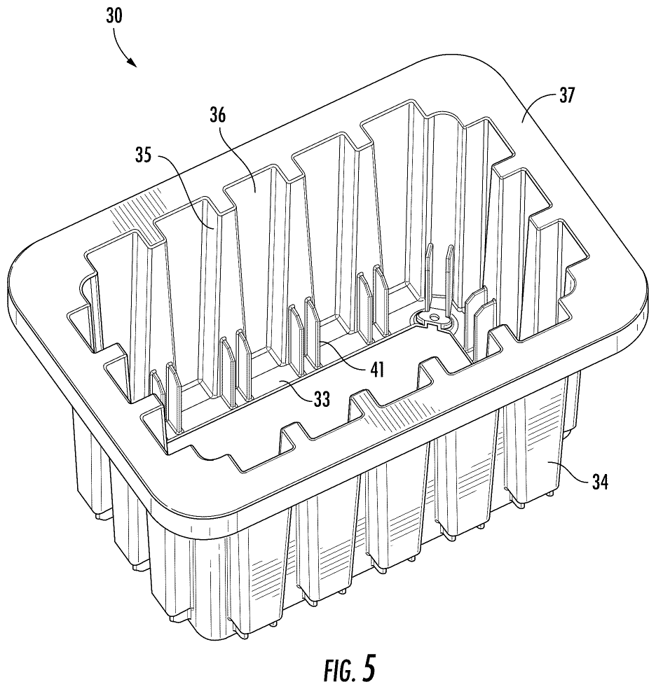

The base 37 of box 30 includes a webbed footer or footing 42 (FIG. 4), adding additional structural rigidity while helping to remove material to reduce weight. However, different footer configurations (e.g., solid, etc.) may also be used in different embodiments. It should be noted that the box 30 in the illustrated example is rectangular, but it may take other shapes (e.g., square, round, etc.) in different embodiments. Moreover, access boxes or vaults are known to come in a variety of different sizes for different applications, and the utility box described herein may be fabricated to accommodate such different sizes as well.

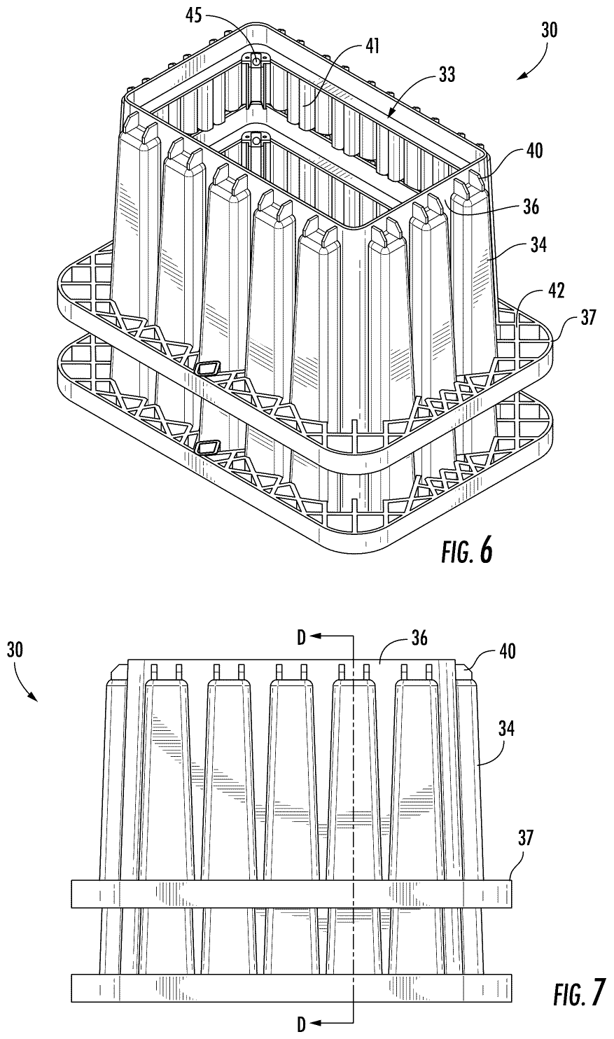

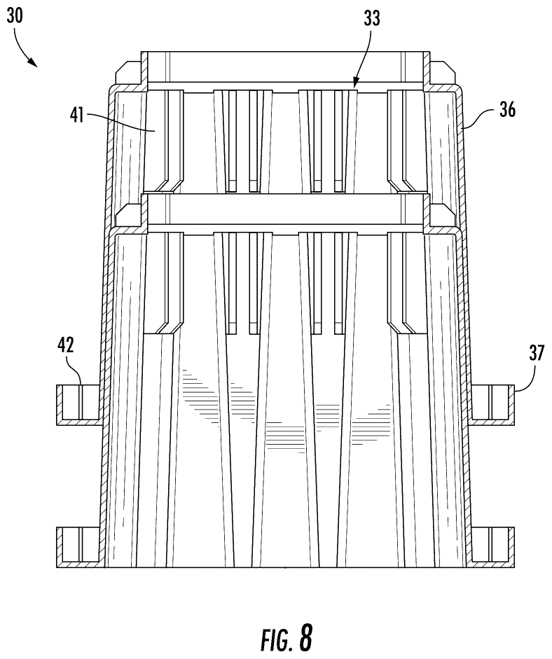

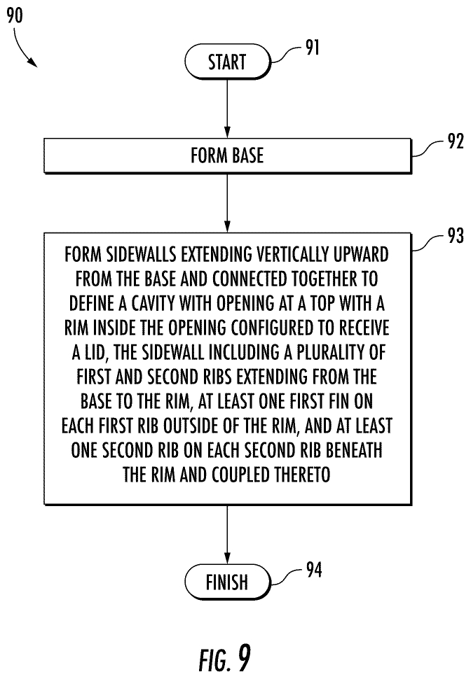

Another significant technical advantage of the utility box 30 is that it is a one-piece configuration which may be easily stacked for shipping and storage, as shown in FIGS. 6-8. The unitary, one-piece configuration is advantageous in that it requires less work to assemble in the field than a two-piece configuration, and may require less time to package for shipping. Moreover, less parts also reduces the chances of pieces getting lost or separated during shipping or storage, for example.

With regard to stacking, the flared walls 36 allow multiple boxes 30 to be stacked one on top of another as noted above. In addition, the interior fins 41 provide a stop that keeps the next box 30 in the stack from sliding all of the way down along the lower box, which allows the boxes to be more easily separated during unstacking. The above-described configuration, including the pyramid shape of the inner and outer ribs 34, 35, also helps provide a technical advantage of easier de-molding during the fabrication process, e.g., after injection molding.

A related method for making the box 30 is now described with reference to the flow diagram 90 of FIG. 9. Beginning at Block 91, the method illustratively includes forming the base 37 and the plurality of sidewalls 36 extending vertically upward from the base, at Blocks 92-93. As discussed further above, the base 36 and sidewalls 36 may be integrally formed as a single, unitary body in a mold (e.g., from HPDE), although in some embodiments they could be formed as separate pieces. After demolding, the box 30 may be stacked with others for ease of storage and shipping, and its configuration allows for easy unstacking for deployment, as noted above. The method of FIG. 9 illustratively concludes at Block 94.

Many modifications and other embodiments of the invention will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A utility access system comprising:
a base;
a plurality of sidewalls extending vertically upward from the base and connected together to define a cavity therein with an opening at a top thereof and a rim inside the opening; and
a lid configured to close the opening when received by the rim;
each of the sidewalls comprising
a plurality of first and second ribs extending from the base to the rim, the first ribs extending outwardly away from the rim and the second ribs extending inwardly beneath the rim, and
at least one first fin on each first rib outside of the rim, and at least one second fin on each second rib beneath the rim and coupled thereto.

2. The utility access system of claim 1 wherein the first and second ribs are arranged in an alternating fashion along each sidewall.

3. The utility access system of claim 1 wherein the at least one first fin comprises a pair of spaced apart first fins at a top of each first rib.

4. The utility access system of claim 1 wherein the at least one second fin comprises a pair of spaced apart second fins.

5. The utility access system of claim 1 wherein the first and second ribs comprise elongated isosceles trapezoids.

6. The utility access system of claim 1 wherein the base comprises a webbed footer surrounding the cavity.

7. The utility access system of claim 1 wherein the base and plurality of sidewalls define a unitary body.

8. The utility access system of claim 1 wherein the base and plurality of sidewalls comprise high-density polyethylene (HPDE).

9. A utility access vault comprising:
a base; and
a plurality of sidewalls extending vertically upward from the base and connected together to define a cavity therein with an opening at a top thereof and a rim inside the opening configured to receive a lid;
each of the sidewalls comprising
a plurality of first and second ribs extending from the base to the rim, the first ribs extending outwardly away from the rim and the second ribs extending inwardly beneath the rim, and
at least one first fin on each first rib outside of the rim, and at least one second fin on each second rib beneath the rim and coupled thereto.

10. The utility access vault of claim 9 wherein the first and second ribs are arranged in an alternating fashion along each sidewall.

11. The utility access vault of claim 9 wherein the at least one first fin comprises a pair of spaced apart first fins at a top of each first rib.

12. The utility access vault of claim 9 wherein the at least one second fin comprises a pair of spaced apart second fins.

13. The utility access vault of claim 9 wherein the first and second ribs comprise elongated isosceles trapezoids.

14. The utility access vault of claim 9 wherein the base comprises a webbed footer surrounding the cavity.

15. A method for making a utility access vault comprising:
forming a base and a plurality of sidewalls extending vertically upward from the base and connected together to define a cavity therein with an opening at a top thereof and a rim inside the opening configured to receive a lid;
wherein forming the sidewalls comprises
forming a plurality of first and second ribs extending from the base to the rim, the first ribs extending outwardly away from the rim and the second ribs extending inwardly beneath the rim, and
forming at least one first fin on each first rib outside of the rim, and forming at least one second fin on each second rib beneath the rim and coupled thereto.

16. The utility access vault of claim 15 wherein forming the first and second ribs comprises forming the first and second ribs in an alternating fashion along each sidewall.

17. The utility access vault of claim 15 wherein forming the at least one first fin comprises forming a pair of spaced apart first fins at a top of each first rib.

18. The utility access vault of claim 15 wherein the at least one second fin comprises a pair of spaced apart second fins.

19. The utility access vault of claim 15 wherein the first and second ribs comprise elongated isosceles trapezoids.

20. The utility access vault of claim 15 wherein forming the base comprises forming a webbed footer surrounding the cavity.
